(19) United States
(12) Patent Application Publication
(10) Pub. No.: US 2025/0170727 A1
(43) Pub. Date: May 29, 2025

(54) HAND

(71) Applicant: KAWASAKI JUKOGYO KABUSHIKI KAISHA, Kobe-shi, Hyogo (JP)

(72) Inventor: Hideshi YAMANE, Kobe-shi (JP)

(73) Assignee: KAWASAKI JUKOGYO KABUSHIKI KAISHA, Kobe-shi, Hyogo (JP)

(21) Appl. No.: 18/843,587

(22) PCT Filed: Feb. 28, 2023
(86) PCT No.: PCT/JP2023/007426

§ 371 Date: Sep. 3, 2024

(30) Foreign Application Priority Data
Mar. 4, 2022 (JP) 2022-033880

(51) Int. Cl. B25J 15/00; B25J 15/06

(52) U.S. Cl. CPC B25J 15/0014; B25J 15/0061; B25J 15/0616

(57) ABSTRACT

A hand includes: a base; a first holder that is supported to be movable in a predetermined first direction with respect to the base and holds an article; a first driver that moves the first holder in the first direction; and a second holder that is aligned with the first holder in a second direction intersecting with the first direction, is supported to be movable in the first direction with respect to the base, and holds the article. The article held by the first holder and the second holder is placed on the base. The second holder is capable of adjusting a distance from the first holder in the second direction.

### FIELD

The technique disclosed here relates to a hand.

### BACKGROUND

A known hand includes a holder that holds an article. Patent Document 1, for example, discloses a hand including a holder that holds an article and a base on which an article is placed. The hand moves the holder holding an article in a predetermined direction and places the article on the base. The hand conveys the article in a state where the article is placed on the base.

### CITATION LIST

### Patent Document

Patent Document 1: International Patent Publication No. 2021/025019

### SUMMARY

The hand is designed to hold articles of various sizes by enlarging the holder. However, the hand is desired to have further enhanced conveyance performance and there is room for further improvement in such a hand.

It is therefore an object of the technique disclosed here to enhance conveyance performance of a hand that places an article on a base with a hand and conveys the article.

A hand disclosed here includes: a base; a first holder that is supported to be movable in a predetermined first direction with respect to the base and holds an article; a first driver that moves the first holder in the first direction; and a second holder that is aligned with the first holder in a second direction intersecting with the first direction, is supported to be movable in the first direction with respect to the base, and holds the article, wherein the base allows the article held by the first holder and the second holder to be placed on the base, and the second holder is capable of adjusting a distance from the first holder in the second direction.

The hand can enhance conveyance performance.

### BRIEF DESCRIPTION OF THE DRAWINGS

FIG. 1 illustrates a configuration of a robot system.

FIG. 2 is a perspective view of a hand.

FIG. 3 is a perspective view of the hand in a state different from FIG. 2.

FIG. 4 is a front view of the hand.

FIG. 5 is a side view of the hand.

FIG. 6 is a bottom view of the hand.

FIG. 7 is a schematic hardware configuration of a controller.

FIG. 8 is a functional block diagram of a processor.

FIG. 9 is a flowchart of transfer of articles.

### DESCRIPTION OF EMBODIMENTS

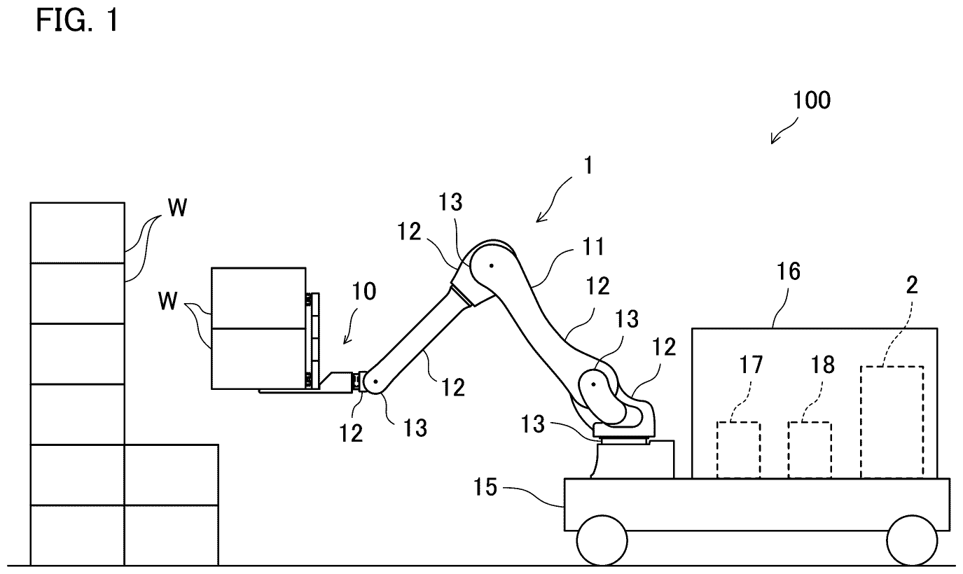

An exemplary embodiment will be described in detail hereinafter with reference to the drawings. FIG. 1 illustrates a configuration of a robot system 100.

The robot system 100 is a system that transfers articles. This embodiment is directed to a case where articles W stacked at a predetermined position are transferred to a target position. The articles W are, for example, cardboard boxes. The robot system 100 includes a robot 1 that transfers articles W and a controller 2 that controls the robot 1.

The robot 1 is, for example, an industrial robot. The robot 1 includes a robot arm 11 and a hand 10 coupled to the robot arm 11. In this example, the robot 1 further includes a carrier 15 and an equipment housing 16. The robot arm 11 is mounted on the carrier 15. The equipment housing 16 houses equipment necessary for controlling the robot 1 including the controller 2. The robot 1 autonomously moves by the carrier 15.

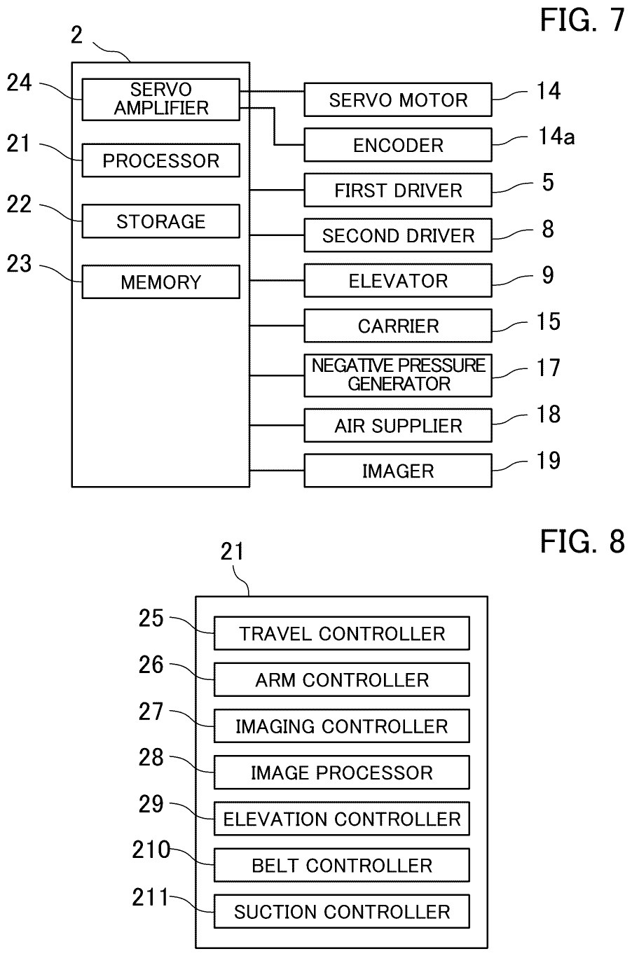

The robot arm 11 changes the position and posture of the hand 10. The robot arm 11 is a vertical articulated robot arm. The robot arm 11 includes links 12, joints 13 connecting the links 12, and a servo motor 14 (see FIG. 7) that rotationally drives the joints 13. For example, the link 12 at one end of the robot arm 11 is coupled to the carrier 15 through the joint 13 to be rotatable about a rotation axis extending in the vertical direction. The robot arm 11 may be of a horizontal articulated type, a parallel link type, a Cartesian coordinate type, a polar coordinate type, or other types.

The hand 10 is an end effector of the robot arm 11. The hand 10 is coupled to the distal end of the robot arm 11. Specifically, the hand 10 is coupled to the link 12 at the opposite side to the link 12 coupled to the carrier 15. The hand 10 can take various postures depending on actions of the robot arm 11.

The carrier 15 moves the robot 1 on the floor or other places. The carrier 15 is not limited to an object that travels with wheels, and only needs to include a travelling device such as a crawler. The carrier 15 may be an automated guided vehicle (AGV), for example.

The equipment housing 16 houses a negative pressure generator 17 and an air supplier 18 in addition to the controller 2. The negative pressure generator 17 generates a negative pressure at suction pads 41 and suction pads 61 described later. For example, the negative pressure generator 17 is a vacuum pump. The air supplier 18 pumps air. The air supplier 18 supplies air to components such as a first fixed driver 82 and a second fixed driver 83 described later. For example, the air supplier 18 is an air pump. The negative pressure generator 17 and the air supplier 18 are controlled by the controller 2.

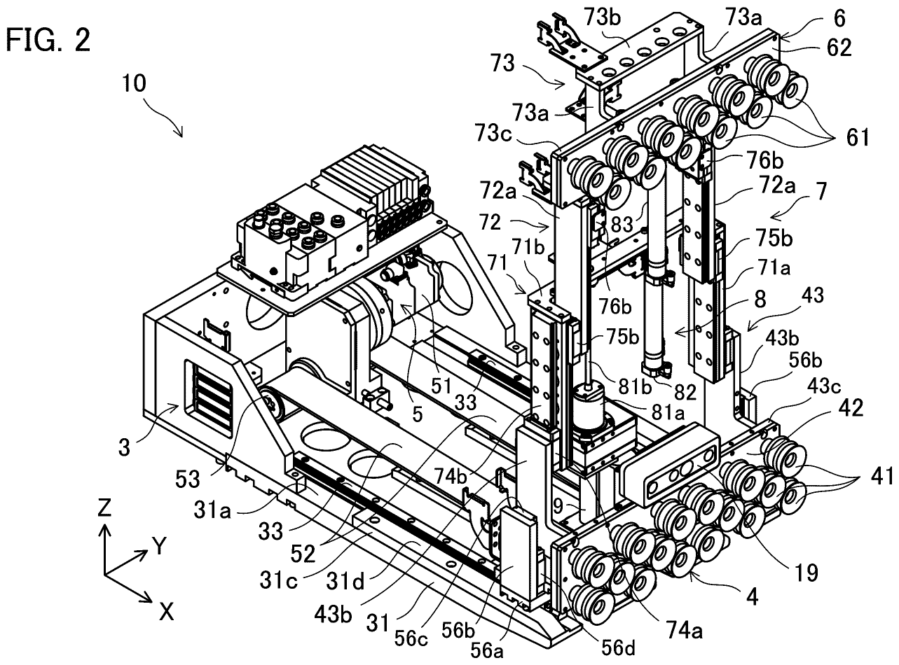

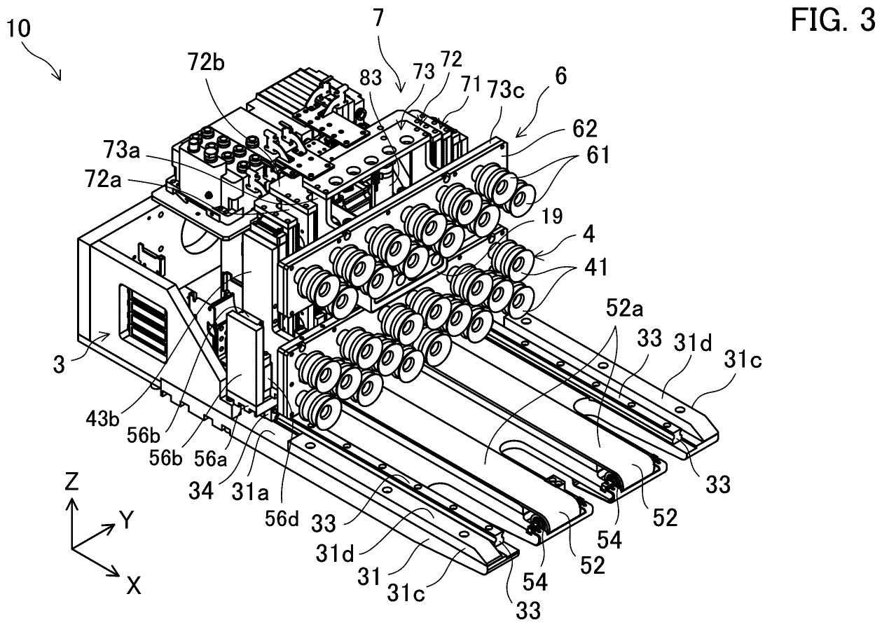

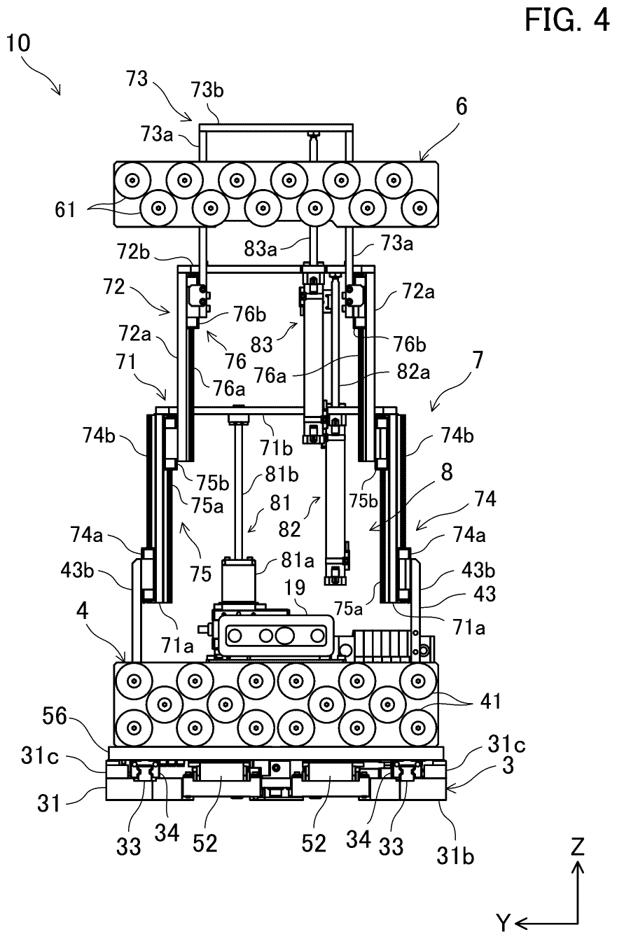

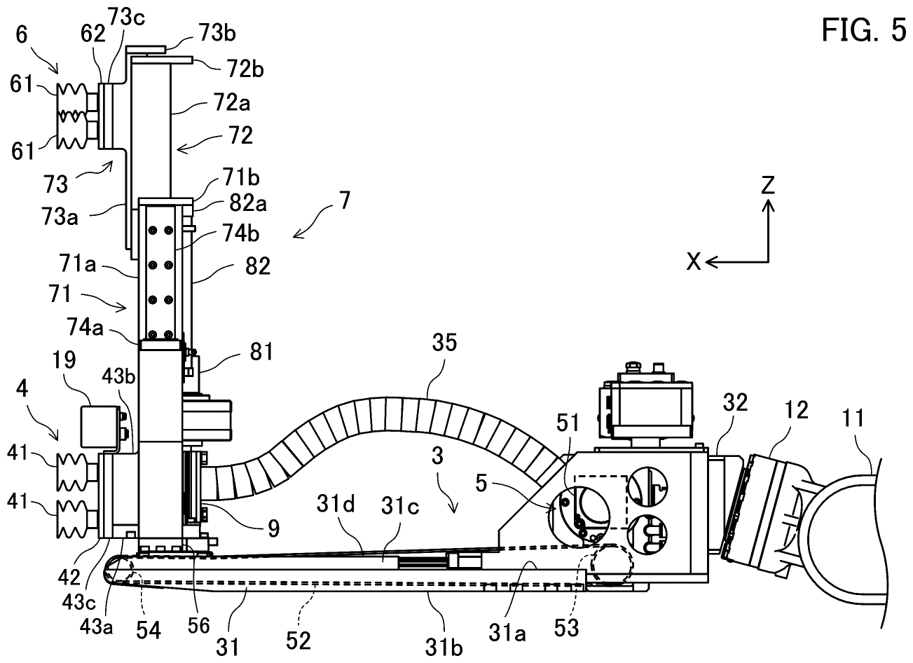

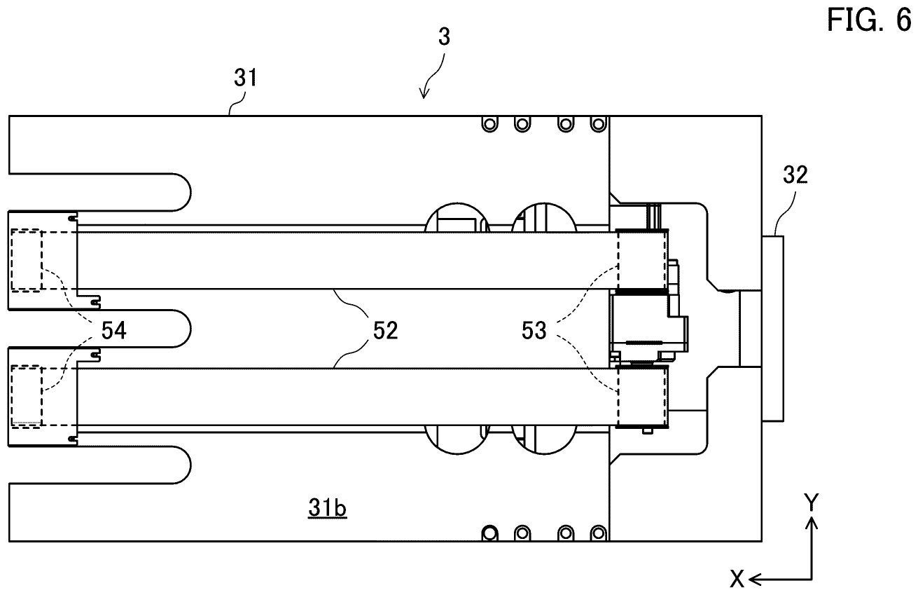

A configuration of the hand 10 will now be described in detail. FIG. 2 is a perspective view of the hand 10. FIG. 3 is a perspective view of the hand 10 in a state different from FIG. 2. FIG. 4 is a front view of the hand 10. FIG. 5 is a side view of the hand 10. FIG. 6 is a bottom view of the hand 10. FIG. 2 shows a state where the distance from a first holder 4 to a second holder 6 is at maximum and the first holder 4 and the second holder 6 are advanced most forward. FIG. 3 shows a state where the distance from the first holder 4 to the second holder 6 is at minimum and the first holder 4 and the second holder 6 are retracted most rearward.

The hand 10 includes a base 3, the first holder 4 that holds articles W, a first driver 5, and the second holder 6 that holds articles. The first holder 4 is supported to be movable in a predetermined first direction X with respect to the base 3. The first driver 5 moves the first holder 4 in the first direction. The second holder 6 is aligned with the first holder 4 in a predetermined second direction Z and supported to be movable in the first direction X with respect to the base 3. The base 3 allows articles W held by the first holder 4 and the second holder 6 to be placed on the base 3. The hand 10 holds the articles W by the first holder 4 and the second holder 6 and moves the first holder 4 and the second holder 6 holding the articles W in the first direction X to thereby place the articles W on the base 3.

Then, the second holder 6 is capable of adjusting the distance from the first holder 4 in the second direction Z. That is, the second holder 6 is capable of adjusting an interval between the first holder 4 and the second holder 6 in the second direction Z. The hand 10 may further include a guide 7 that supports the second holder 6 such that the second holder 6 is movable in the second direction Z and a second driver 8 that moves the second holder 6 in the second direction Z. That is, the second holder 6 is moved by the second driver 8 in the second direction Z while being guided by the guide 7 in the second direction Z. In this manner, the distance from the first holder 4 to the second holder 6 in the second direction Z is adjusted.

In this example, the second direction Z is substantially orthogonal to the first direction X. Specifically, the second direction Z is the top-bottom direction. A direction substantially orthogonal to both the first direction X and the second direction Z is defined as a third direction Y. Each of the first direction X, the second direction Z, and the third direction Y refers to a direction regardless of orientation.

More specifically, the base 3 includes a base plate 31 on which articles W held by the first holder 4 are placed. The base plate 31 has a substantially rectangular outer shape whose longitudinal direction extends in the first direction X and lateral direction extends in the third direction Y in a plan view. The thickness direction of the base plate 31 coincides with the second direction Z. The base plate 31 has an upper surface 31a and a bottom surface 31b facing opposite the upper surface 31a. The base plate 31 also includes two sliding plates 31c located at both ends of the upper surface 31a in the third direction Y and extending in the first direction X. The sliding plates 31c has a placement surface 31d on which articles W held by the first holder 4 are placed. The placement surface 31d faces in the second direction Z, specifically, faces upward. The placement surface 31d has a relatively small friction coefficient and functions as a sliding surface along which the articles W slide.

As illustrated in FIG. 5, an attachment 32 to which the distal end of the robot arm 11 is attached is located at one end of the base plate 31 in the first direction X. The link 12 at the distal end of the robot arm 11 is attached to the attachment 32. The hand 10 can take any posture by moving the robot arm 11.

The configuration of the hand 10 will be described in a posture in which the direction of the base plate 31, that is, the second direction Z, is oriented in the top-bottom direction for convenience of description. This posture is a posture when the hand 10 is usually used, and will be referred to as a basic posture. In the first direction X, a side of the attachment 32 will be referred to as rear, and the side opposite to the attachment 32 will be referred to as front. That is, in the first direction X, a side away from the robot arm 11 will be referred to as forward, and a side toward the robot arm 11 will be referred to as rearward.

Two rails 33 are located on the upper surface 31a of the base plate 31 and extend in the first direction X. As illustrated in FIGS. 3 and 4, blocks 34 are attached to the rails 33 to be movable in the first direction X. That is, the rails 33 and the blocks 34 constitute a linear guide slidable in the first direction X.

The first driver 5 includes a motor 51 and transfer belts 52 that transfer a driving force of the motor 51. More specifically, the first driver 5 includes two transfer belts 52.

The motor 51 is an electric motor capable of performing forward-reverse rotation. The motor 51 is attached to the base plate 31. More specifically, as illustrated in FIGS. 2 and 5, the motor 51 is located on a rear end portion of the base plate 31 in the first direction X. The motor 51 is located on the base 3 without projecting from the bottom surface 31b.

The transfer belts 52 are endless belts. As illustrated in FIG. 5, each of the transfer belts 52 is wound about a corresponding pair of a driving roller 53 and a driven roller 54 located on the base plate 31. The driving roller 53 and the driven roller 54 in each pair are arranged side by side in the first direction X on the base plate 31. The driving roller 53 is located on a rear end portion of the base plate 31 in the first direction X, and the driven roller 54 is located on a front end portion of the base plate 31 in the first direction X. The axis of the driving roller 53 and the axis of the driven roller 54 extend in the third direction Y. Each of the driving roller 53 and the driven roller 54 is located on the base plate 31 to be rotatable about the axis. Specifically, each of the driving roller 53 and the driven roller 54 is located in a through hole penetrating the base plate 31 in the thickness direction.

A driving force of the motor 51 is transferred to the driving roller 53 through a decelerator such as a gear train. The motor 51 is shared by two driving rollers 53.

As illustrated in FIGS. 2 and 3, the transfer belts 52 extends in the first direction X along the upper surface 31a of the base plate 31, is wound about the driving roller 53, and turns toward the bottom surface 31b of the base plate 31 through the through hole, and as illustrated in FIG. 6, extends in the first direction X along the bottom surface 31b, is wound about the driven roller 54, and turns toward the upper surface 31a of the base plate 31. Consequently, the transfer belts 52 is located on the base plate 31 and extends along the base plate 31. The two transfer belts 52 are arranged side by side in the third direction Y.

The first holder 4 is coupled to the transfer belts 52. Specifically, a carriage 56 is fixed to the transfer belts 52. The carriage 56 is fixed to portions of the transfer belts 52 extending along the upper surface 31a. The carriage 56 is also fixed to the blocks 34. That is, the carriage 56 is driven by the transfer belts 52 in the first direction X and is guided by the rails 33 in the first direction X. The carriage 56 is immovable in the second direction Z and the third direction Y. The carriage 56 supports the first holder 4.

As illustrated in FIG. 2, the first holder 4 includes suction pads 41, a back plate 42 supporting the suction pads 41, and a support base 43 to which the back plate 42 is attached.

The support base 43 includes a bottom wall 43a, a pair of support walls 43b located on the bottom wall 43a, and an attachment plate 43c to which the back plate 42 is attached. As illustrated in FIG. 5, the bottom wall 43a extends in the third direction Y with the thickness direction thereof oriented in the second direction Z. The pair of support walls 43b is located at both ends of the bottom wall 43a in the third direction Y. The pair of support walls 43b extends in the second direction Z with the thickness direction thereof oriented in the third direction Y. The attachment plate 43c is fixed to the bottom wall 43a and the pair of support walls 43b with the thickness direction thereof oriented in the first direction X. The attachment plate 43c is located forward of the bottom wall 43a and the pair of support walls 43b.

The back plate 42 is attached to the attachment plate 43c with the thickness direction thereof oriented in the first direction X.

The suction pads 41 are hollow pads having an accordion shape. The suction pads 41 are deformable. The suction pads 41 are attached to a surface of the back plate 42 facing forward. The suction pads 41 are arranged in columns and rows on the back plate 42. Each of the suction pads 41 has an opening facing forward.

The suction pads 41 are connected to the negative pressure generator 17 through tubes. When the negative pressure generator 17 generates a negative pressure, an object that approaches or contacts the openings of the suction pads 41 are thereby sucked. The suction pads 41 can be connected to the negative pressure generator 17 through a common tube system or tubes systems independent of each other. In the case where the suction pads 41 are connected to the negative pressure generator 17 through the independent tube systems, the suction pads 41 can perform suction individually or in units of groups.

The carriage 56 supports the thus-configured first holder 4 such that the first holder 4 is movable in the second direction Z and immovable in the first direction X and the third direction Y.

Specifically, as illustrated in FIG. 2, the carriage 56 includes a bottom wall 56a, a pair of support walls 56b located on the bottom wall 56a, a pair of rails 56c fixed to the support walls 56b, and a pair of blocks 56d connected to the pair of rails 56c to be slidable in the second direction Z.

The pair of support walls 56b are arranged side by side with an interval in the third direction Y with the thickness direction thereof oriented in the third direction Y. Each of the support walls 56b extends in the second direction Z, that is, in the top-bottom direction. A corresponding to one of the rails 56c is fixed to each support wall 56b. The rails 56c extend in the second direction Z. The rails 56c and the blocks 56d constitute a linear guide slidable in the second direction Z. The pair of rails 56c and the pair of blocks 56d are located inside the pair of support walls 56b and outside the pair of support walls 43b of the support base 43 in the third direction Y.

The pair of blocks 56d is fixed to the pair of support walls 43b. Accordingly, the pair of support walls 43b, that is, the support base 43, is movable along the rails 56c in the second direction Z. Since the first holder 4 is fixed to the support base 43, the first holder 4 is also movable in the second direction Z.

In addition, as illustrated in FIG. 5, an elevator 9 that moves the first holder 4 in the second direction Z, that is, in the top-bottom direction, is disposed to the first holder 4 and the carriage 56. The elevator 9 is located rearward of the attachment plate 43c on the bottom wall 43a.

The elevator 9 is an air cylinder. The elevator 9 includes a piston rod extending in the second direction Z and movable in the second direction Z. The elevator 9 is fixed to the support base 43 of the first holder 4 and the piston rod is fixed to the bottom wall 56a of the carriage 56. The air supplier 18 is connected to the elevator 9 through an air tube. The air tube includes a solenoid valve that switches an air supply state to the elevator 9. The elevator 9 selectively moves the piston rod between a first position at which the piston rod is retracted and a second position at which the piston rod is advanced by switching the air supply state. The first position is a position at which the support base 43 approaches closest to the bottom wall 56a, and the position of the first holder 4 at this time is a lowest position in the second direction Z. The second position is a position at which the support base 43 is farthest from the bottom wall 56a, and in this state, the position of the first holder 4 is the highest position in the second direction Z.

In the manner described above, the first holder 4 is supported by the carriage 56 to be movable in the second direction Z and moved by the elevator 9 in the second direction Z.

As illustrated in FIG. 2, the second holder 6 is attached to the carriage 56 through the guide 7. The second holder 6 includes the suction pads 61 and a back plate 62 supporting the suction pads 61. The back plate 62 is located with the thickness direction thereof oriented in the first direction X.

The suction pads 61 are hollow pads having an accordion shape. The suction pads 61 are deformable. The suction pads 61 are attached to a surface of the back plate 62 facing forward. The suction pads 61 are arranged in columns and rows on the back plate 62. Each of the suction pads 61 has an opening facing forward.

The suction pads 61 are connected to the negative pressure generator 17 through tubes. When the negative pressure generator 17 generates a negative pressure, an object that approaches or contacts the openings of the suction pads 61 are thereby sucked. The suction pads 61 can be connected to the negative pressure generator 17 through a common tube system or tube systems independent of each other. In a case where the suction pads 61 are connected to the negative pressure generator 17 through the independent tube systems, the suction pads 61 can perform suction individually or in units of groups.

The first driver 5 moves the carriage 56 in the first direction X by moving the transfer belts 52 by the motor 51. Accordingly, the first driver 5 moves the first holder 4 in the first direction X. Since the second holder 6 is also attached to the carriage 56 through the guide 7, the first driver 5 moves both the first holder 4 and the second holder 6 in the first direction X. The first driver 5 moves the first holder 4 and the second holder 6 between a predetermined first position and a second position located rearward of the first position in the first direction X. As illustrated in FIGS. 2 and 5, the first position is a position at which the suction pads 41 of the first holder 4 and the suction pads 61 of the second holder 6 project forward of the front end of the base plate 31 in the first direction X. The first position is a position at which the first holder 4 and the second holder 6 perform suction of articles W. As illustrated in FIG. 3, the second position is a position at which the suction pads 41 and the suction pads 61 are retracted rearward from the front end of the base plate 31 in the first direction X. The second position is a position at which the articles W held by the first holder 4 and the second holder 6 are placed on the base plate 31.

As illustrated in FIG. 3, each of the transfer belts 52 has a conveyance surface 52a on which the articles W held by the first holder 4 are placed. The conveyance surface 52a is an outer peripheral surface of the transfer belt 52. Specifically, while the first holder 4 is located at the second position, a portion of the transfer belts 52 is exposed at the upper surface 31a of the base plate 31 at a position forward of the first holder 4. The outer peripheral surface of the portion of each of the transfer belts 52 located forward of the first holder 4 on the upper surface 31a of the base plate 31 is the conveyance surface 52a. That is, each transfer belt 52 moves the conveyance surface 52a together with the first holder 4. The position of the conveyance surface 52a in the second direction Z, that is, the height in the top-bottom direction, is substantially the same as that of the placement surface 31d. The conveyance surface 52a has a friction coefficient larger than a friction coefficient of the placement surface 31d.

As illustrated in FIG. 4, the guide 7 includes a first mover 71, a first guide 74 that supports the first mover 71 to such that the first mover 71 is movable in the second direction Z with respect to the base 3, a second mover 72 on which the second holder 6 is mounted, and a second guide 75 that supports the second mover 72 such that the second mover 72 is movable in the second direction Z with respect to the first mover 71. In this example, the second holder 6 is mounted on the second mover 72 through a third mover 73 and a third guide 76. The second holder 6 is attached to the third mover 73. The third guide 76 supports the third mover 73 such that the third mover 73 is movable in the second direction Z with respect to the second mover 72. The second mover 72 is located above the first mover 71. The third mover 73 is located above the second mover 72.

The first guide 74 includes a pair of blocks 74a fixed to the support base 43 and rails 74b coupled to the blocks 74a to be slidable in the second direction Z.

The pair of blocks 74a is located inside the pair of support walls 43b of the support base 43 in the third direction Y. Each of the blocks 74a is fixed to the upper end of a corresponding one of the support walls 43b. The two rails 74b are also located inside the pair of support walls 43b in the third direction Y. The rails 74b extend in the second direction Z. The blocks 74a and the rails 74b constitute a linear guide slidable in the second direction Z. In this example, since the blocks 74a are fixed to the support walls 43b, the rails 74b move in the second direction Z with respect to the support walls 43b.

The first mover 71 includes a pair of support walls 71a and a coupling wall 71b coupling the pair of support walls 71a to each other.

The pair of support walls 71a is arranged side by side with an interval in the third direction Y with the thickness direction thereof oriented in the third direction Y. The pair of support walls 71a is located inside the two rails 74b in the third direction Y. Each of the support walls 71a extends in the second direction Z, that is, in the top-bottom direction. Each of the support walls 71a is fixed to a corresponding one of the rails 74b. The coupling wall 71b is fixed to the upper ends of the pair of support walls 71a. Since the pair of support walls 71a is fixed to the two rails 74b, the first mover 71 moves in the second direction Z together with the rails 74b as the rails 74b move in the second direction Z.

The second guide 75 includes a pair of rails 75a fixed to the pair of support walls 71a of the first mover 71 and a pair of blocks 75b coupled to the pair of rails 75a to be slidable in the second direction Z.

The pair of rails 75a is arranged side by side with an interval in the third direction Y. The pair of rails 75a is located inside the pair of support walls 71a in the third direction Y. Each of the rails 75a extends in the second direction Z, that is, in the top-bottom direction. Each of the rails 75a is fixed to a corresponding one of the support walls 71a. The pair of blocks 75b is also located inside the pair of support walls 71a in the third direction Y. The rails 75a and the blocks 75b constitute a linear guide slidable in the second direction Z. Since the rails 75a are fixed to the support walls 71a, the blocks 75b move in the second direction Z with respect to the support walls 71a.

The second mover 72 includes a pair of support walls 72a and a coupling wall 72b coupling the pair of support walls 72a to each other.

The pair of support walls 72a is arranged side by side with an interval in the third direction Y with the thickness direction thereof oriented in the third direction Y. The pair of support walls 72a is located inside the pair of blocks 75b in the third direction Y. Each of the support walls 72a extends in the second direction Z, that is, in the top-bottom direction. Each of the support walls 72a is fixed to a corresponding one of the blocks 75b. The lower ends of the support walls 72a are fixed to the blocks 75b. The coupling wall 72b is fixed to the upper ends of the pair of support walls 72a. Since the pair of support walls 72a is fixed to the two blocks 75b, the second mover 72 moves together with the blocks 75b in the second direction Z as the blocks 75b move in the second direction Z.

In this example, as illustrated in FIG. 2, the coupling wall 71b of the first mover 71 is displaced from the pair of support walls 71a in the first direction X. Accordingly, the support walls 72a fixed to the blocks 75b and extending in the second direction Z do not interfere with the coupling wall 71b.

The third guide 76 includes a pair of rails 76a fixed to the pair of support walls 72a of the second mover 72 and a pair of blocks 76b coupled to the pair of rails 76a to be slidable in the second direction Z.

The pair of rails 76a is arranged side by side with an interval in the third direction Y. The pair of rails 76a is located inside the pair of support walls 72a in the third direction Y. Each of the rails 76a extends in the second direction Z, that is, in the top-bottom direction. Each of the rails 76a is fixed to a corresponding one of the support walls 72a. The pair of blocks 76b is also located inside the pair of support walls 72a in the third direction Y. The rails 76a and the blocks 76b constitute a linear guide slidable in the second direction Z. Since the rails 76a are fixed to the support walls 72a, the blocks 76b move in the second direction Z with respect to the support walls 72a.

The third mover 73 includes a pair of support walls 73a and a coupling wall 73b coupling the pair of support walls 73a to each other.

The pair of support walls 73a is arranged side by side with an interval in the third direction Y with the thickness direction thereof oriented in the third direction Y. The pair of support walls 73a is located inside the pair of blocks 76b in the third direction Y. Each of the support walls 73a extends in the second direction Z, that is, in the top-bottom direction. Each of the support walls 73a is fixed to a corresponding one of the blocks 76b. The coupling wall 73b is fixed to the upper ends of the pair of support walls 73a. Since the pair of support walls 73a is fixed to the two blocks 76b, the third mover 73 moves together with the blocks 76b in the second direction Z as the blocks 76b move in the second direction Z.

In this example, as illustrated in FIG. 3, the coupling wall 72b of the second mover 72 is displaced from the pair of support walls 72a in the first direction X. Accordingly, the support walls 73a fixed to the blocks 76b and extending in the second direction Z do not interfere with the coupling wall 72b.

As illustrated in FIGS. 2, 3, and 5, an attachment plate 73c is coupled to the pair of support walls 73a of the third mover 73. The thickness direction of the attachment plate 73c is oriented in the first direction X. The second holder 6 is attached to the attachment plate 73c. Specifically, the back plate 62 of the second holder 6 is attached to the attachment plate 73c with the thickness direction thereof oriented in the first direction X.

As illustrated in FIG. 4, the second driver 8 includes an adjustable driver 81 capable of adjusting the amount of movement of the second holder 6, a first fixed driver 82 that moves the second holder 6 with a constant amount of movement, and a second fixed driver 83 that moves the second holder 6 with a constant amount of movement. The adjustable driver 81 drives the first mover 71. The first fixed driver 82 drives the second mover 72. The second fixed driver 83 drives the third mover 73.

The adjustable driver 81 is an electric cylinder. Specifically, the adjustable driver 81 includes a motor 81a and a rod 81b. The rod 81b extends in the second direction Z. The rod 81b includes a ball screw mechanism that is rotationally driven by the motor 81a. When the motor 81a operates, the rod 81b thereby moves in the second direction Z. The motor 81a of the adjustable driver 81 is fixed to the carriage 56. The rod 81b is fixed to the coupling wall 71b of the first mover 71. The adjustable driver 81 moves the first mover 71 in the second direction Z by operating the motor 81a.

The adjustable driver 81 continuously adjusts the position, that is, the advance amount, of the rod 81b in the second direction Z within a predetermined adjustable range by adjusting the rotation amount of the motor 81a. That is, the adjustable driver 81 adjusts the amount of movement of the first mover 71 in the second direction Z within the adjustable range by adjusting the rotation amount of the motor 81a.

The first fixed driver 82 is an air cylinder. The first fixed driver 82 includes a piston rod 82a. The piston rod 82a extends in the second direction Z. The first fixed driver 82 moves the piston rod 82a in the second direction Z. The first fixed driver 82 is fixed to the coupling wall 71b of the first mover 71. The piston rod 82a is fixed to the coupling wall 72b of the second mover 72.

The air supplier 18 is connected to the first fixed driver 82 through an air tube. The air tube includes a solenoid valve that switches an air supply state to the first fixed driver 82. The first fixed driver 82 selectively moves the piston rod 82a between a first position at which the piston rod 82a is retracted and a second position at which the piston rod 82a is advanced by switching the air supply state. The first fixed driver 82 moves the second mover 72 in the second direction Z with respect to the first mover 71 by advancing or retracting the piston rod 82a between the first position and the second position. The amount of movement of the piston rod 82a, that is, the amount of movement of the second mover 72, is constant at a first distance between the first position and the second position. For example, the first distance is less than or equal to a maximum amount of movement of the first mover 71 by the adjustable driver 81.

The second fixed driver 83 has a configuration similar to that of the first fixed driver 82. The second fixed driver 83 includes an air cylinder including a piston rod 83a. The second fixed driver 83 is fixed to the coupling wall 72b of the second mover 72. The piston rod 83a is fixed to the coupling wall 73b of the third mover 73.

The air supplier 18 is connected to the second fixed driver 83 through an air tube, and supplies air to the second fixed driver 83 independently of the first fixed driver 82. The second fixed driver 83 selectively moves the piston rod 83a in the second direction Z between a first position at which the piston rod 83a is retracted and a second position at which the piston rod 83a is advanced by switching the air supply state. The second fixed driver 83 moves the third mover 73 in the second direction Z with respect to the second mover 72 by advancing or retracting the piston rod 83a between the first position and the second position. The amount of movement of the piston rod 83a, that is, the amount of movement of the third mover 73, is constant at a second distance between the first position and the second position. For example, the second distance is less than or equal to the maximum amount of movement of the first mover 71 by the adjustable driver 81.

The second driver 8 moves the second holder 6 in the second direction Z by selectively use the adjustable driver 81, the first fixed driver 82, and the second fixed driver 83. The second driver 8 causes the adjustable driver 81, the first fixed driver 82, and the second fixed driver 83 to operate independently of one another.

Specifically, the second driver 8 moves the first mover 71 in the second direction Z by adjusting the advance amount of the rod 81b of the adjustable driver 81. The second mover 72 is supported by the first mover 71, the third mover 73 is supported by the second mover 72, and the second holder 6 is attached to the third mover 73. Thus, when the first mover 71 moves in the second direction Z, the second mover 72, the third mover 73, and the second holder 6 move in the second direction Z together with the first mover 71. The second driver 8 can arbitrarily adjust the amount of movement of the first mover 71, and accordingly, the amount of movement of the second holder 6, in the second direction Z within an adjustable range of the advance amount of the rod 81b.

The second driver 8 moves the second mover 72 in the second direction Z by changing the advance amount of the piston rod 82b of the first fixed driver 82. The second driver 8 selectively switches the position of the piston rod 82b of the first fixed driver 82 between a first position and a second position. When the piston rod 82b is located at the first position, the second mover 72 is closest to the first mover 71 in the second direction Z. On the other hand, when the piston rod 82b is located at the second position, the second mover 72 is farthest from the first mover 71 in the second direction Z. When the second mover 72 moves in the second direction Z, the third mover 73 and the second holder 6 move in the second direction Z together with the second mover 72. The second driver 8 moves the second mover 72, and accordingly, the second holder 6, in the second direction Z by a constant first distance by switching the position of the piston rod 82b between the first position and the second position.

The second driver 8 moves the third mover 73 in the second direction Z by changing the advance amount of the piston rod 83b of the second fixed driver 83. The second driver 8 selectively switches the position of the piston rod 83b of the second fixed driver 83 between a first position and a second position. When the piston rod 83b is located at the first position, the third mover 73 is closest to the second mover 72 in the second direction Z. On the other hand, when the piston rod 83b is located at the second position, the third mover 73 is farthest from the second mover 72 in the second direction Z. When the third mover 73 moves in the second direction Z, the second holder 6 moves in the second direction Z together with the third mover 73. The second driver 8 moves the third mover 73, and accordingly, the second holder 6, in the second direction Z by a constant second distance by switching the position of the piston rod 83b between the first position and the second position.

In a case where the advance amount of the rod 81b of the adjustable driver 81 is at minimum, the piston rod 82b of the first fixed driver 82 is at the first position, and the piston rod 83b of the second fixed driver 83 is at the first position, a distance from the first holder 4 to the second holder 6 in the second direction Z is a minimum distance. In this example, the distance from the first holder 4 to the second holder 6 in the second direction Z is defined as a distance in the second direction Z between a centroid of a front shape of the first holder 4 and a centroid of a front shape of the second holder 6. In a case where the advance amount of the rod 81b of the adjustable driver 81 is at maximum, the piston rod 82b of the first fixed driver 82 is at the second position, and the piston rod 83b of the second fixed driver 83 is at the second position, the distance from the first holder 4 to the second holder 6 in the second direction Z is a maximum distance. The second driver 8 arbitrarily adjusts the distance from the first holder 4 to the second holder 6 in the second direction Z between the minimum distance and the maximum distance by appropriately combining the adjustable distance by the adjustable driver 81, the first distance by the first fixed driver 82, and the second distance by the second fixed driver 83.

Since each of the first distance and the second distance is less than or equal to the maximum amount of movement of the first mover 71 by the adjustable driver 81, the distance from the first holder 4 to the second holder 6 in the second direction Z can be adjusted in the entire range between the minimum distance and the maximum distance.

The hand 10 further includes an imager 19. The imager 19 is located on an upper portion of the attachment plate 43c. The imager 19 is located between the first holder 4 and the second holder 6 in the second direction Z. The imager 19 is, for example, a stereo camera. The imager 19 generally faces forward in the first direction X. The imager 19 may be a monocular camera, a time-of-flight (TOF) camera, cameras of other types.

As illustrated in FIG. 5, tubes connected to the first holder 4, tubes connected to the second holder 6, wires connected to the adjustable driver 81, tubes connected to the first fixed driver 82, tubes connected to the second fixed driver 83, and wires connected to the imager 19 are housed in an accommodation duct 35 at least in the hand 10. The accommodation duct 35 is freely bendable, and accommodates tubes and cables. The accommodation duct 35 may accommodate tubes and wires other than the tubes and the wires described above. For examples, the tubes and the wires described above are laid out along the robot arm 11, and connected to the corresponding devices such as the controller 2, the negative pressure generator 17, or the air supplier 18. In the hand 10, tubes and wires such as the tubes connected to the first holder 4, the tubes connected to the second holder 6, and the wires connected to the adjustable driver 81 are arranged on the base 3 without projecting from the bottom surface 31b. That is, the accommodation duct 35 is located on the base 3 without projecting from the bottom surface 31b. The accommodation duct 35 is not shown in the drawings except for FIG. 5.

The controller 2 causes the robot 1 to transfer articles W. The controller 2 controls the robot 1 to move the carrier 15, the robot arm 11, and the hand 10, and causes the hand 10 to hold articles W. The controller 2 causes the carrier 15 and the robot arm 11 to move the hand 10 holding the articles W to transfer the articles W to a target position.

FIG. 7 illustrates a schematic hardware configuration of the control device 2. The controller 2 controls the servo motor 14 of the robot arm 11, the first driver 5 of the hand 10, the second driver 8 and the elevator 9, the carrier 15, the negative pressure generator 17, the air supplier 18, and the imager 19. The controller 2 includes a processor 21, a storage 22, a memory 23, and a servo amplifier 24.

The processor 21 controls the entire controller 2. The controller 21 performs various computations. For example, the controller 21 is a processor such as a central processing unit (CPU). The controller 21 may be a micro controller unit (MCU), a micro processor unit (MPU), a field programmable gate array (FPGA), a programmable logic controller (PLC), or the like.

The storage 22 stores programs and various types of data to be executed by the controller 21. The storage 22 is a nonvolatile memory, a hard disc drive (HDD), or a solid state drive (SSD), for example. The memory 23 temporarily stores data or other information. For example, the memory 23 is a volatile memory.

The servo amplifier 24 receives an instruction from the processor 21 and supplies a current to the servo motor 14. The servo amplifier 24 receives a detection result of an encoder 14a included in the servo motor 14. Based on the detection result of the encoder 14a, the servo amplifier 24 performs feedback control on a current applied to the servo motor 14.

FIG. 8 is a functional block diagram of the processor 21. The processor 21 reads a control program from the storage 22 and develops the program to the memory to thereby perform various functions. Specifically, the processor 21 includes a travel controller 25, an arm controller 26, an imaging controller 27, an image processor 28, an elevation controller 29, a belt controller 210, and a suction controller 211.

The travel controller 25 controls the carrier 15. The travel controller 25 controls rotation of the motor of the carrier 15 to thereby move the carrier 15, and accordingly, the robot 1, to a desired position.

The arm controller 26 controls an action of the robot arm 11 such that the hand 10 moves to a position suitable for a purpose such as imaging of articles W, holding of the articles W, or carriage of the articles W. The arm controller 26 also performs operation such as selection of an article W to be held from the articles W. The arm controller 26 generates an angle of each joint 13 in accordance with a target action of the robot arm 11 as an instruction angle, and outputs the generated instruction angle to the servo amplifier 24.

The imaging controller 27 controls the imager 19 and causes the imager 19 to perform imaging.

The image processor 28 processes an image captured by the imager 19 to determine an outer shape, a position, a posture, or other features of the article W. Specifically, the image processor 28 compares the captured image with a template of articles W stored in the storage 22, and extracts articles W in the captured image by a technique such as pattern matching. The image processor 28 outputs an outer shape, a position, a posture, or other features of the extracted article W to the arm controller 26 and the elevation controller 29. The arm controller 26 and the elevation controller 29 use the position, the posture, or other features of the extracted article W in control thereof.

The elevation controller 29 controls the second driver 8 and the elevator 9 of the hand 10. Specifically, in adjusting the distance from the first holder 4 to the second holder 6 in the second direction Z, the elevation controller 29 controls the second driver 8. On the other hand, in moving the entire first holder 4 or second holder 6 in the second direction Z, the elevation controller 29 controls the elevator 9.

The belt controller 210 controls the first driver 5 of the hand 10. Specifically, the belt controller 210 controls the rotation direction and the rotation amount of the motor 51 of the first driver 5 to thereby adjust the positions of the first holder 4 and the second holder 6 in the first direction X.

The suction controller 211 controls operation of the first holder 4 and the second holder 6. Specifically, the suction controller 211 switches the negative pressure generator 17 between operation and stop, and also switches the connection between the negative pressure generator 17 and either the first holder 4 or the second holder 6 between on and off. In this manner, the suction controller 211 switches the first holder 4 and the second holder 6 between suction and cancellation of suction.

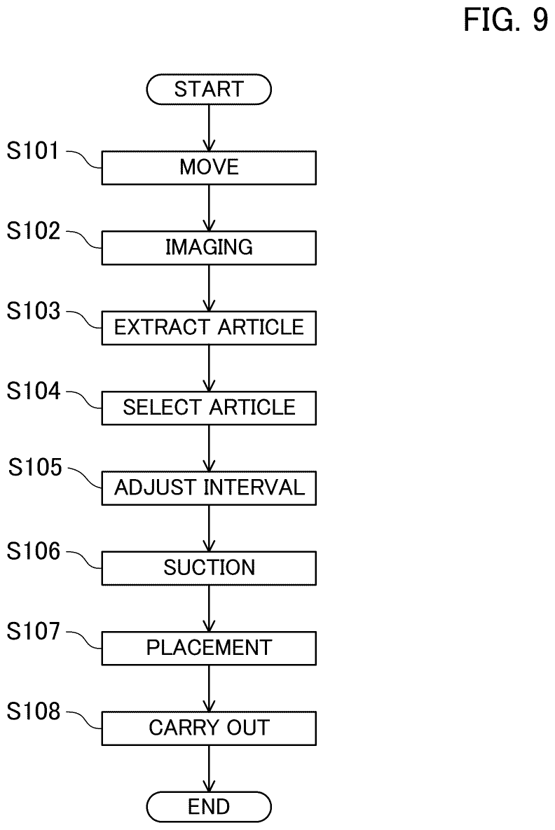

Next, transfer of articles W by the robot system 100 will be described specifically. FIG. 9 is a flowchart of transfer of articles W. Description here is directed to an example case where articles W stacked at a predetermined start position are transferred to a predetermined target position.

First, in step S101, the travel controller 25 controls the carrier 15 to move the robot 1 to a start position.

Then, in step S102, the arm controller 26 moves the robot arm 11 to move the imager 19 to a predetermined imaging position, and the imaging controller 27 causes the imager 19 to perform imaging. In this manner, the imager 19 acquires an image of the stacked articles W.

Thereafter, in step S103, the image processor 28 extracts an outer shape, a position, and a posture of the articles W from the captured image.

Subsequently, in step S104, the arm controller 26 selects an article W to be held by the hand 10 from the articles W, based on an extraction result of the image processor 28. Here, the hand 10 holds two articles W stacked vertically at a time. For example, the arm controller 26 selects an uppermost article W and an article W immediately under the uppermost article W as two articles W to be held, from the articles W.

In step S105, the elevation controller 29 determines a distance from the first holder 4 to the second holder 6 in the second direction Z (hereinafter referred to as a “target distance”). The elevation controller 29 determines the target distance based on the sizes, positions, and others of the selected two articles W. For example, the elevation controller 29 obtains a distance between centroids of front shapes of the two articles W in the second direction Z, and uses the obtained distance as the target distance.

The elevation controller 29 determines a combination of the second driver 8 for achieving the target distance. Specifically, in a case where the target distance is included in a range obtained by adding an adjustable distance of the adjustable driver 81 to the minimum distance from the first holder 4 to the second holder 6, the elevation controller 29 locates the piston rod 82b of the first fixed driver 82 at the first position and the piston rod 83b of the second fixed driver 83 at the first position. In this state, the elevation controller 29 adjusts the advance amount of the rod 81b of the adjustable driver 81 so that the distance from the first holder 4 to the second holder 6 thereby coincides with the target distance. In the hand 10 illustrated in FIG. 3, the piston rod 82b and the piston rod 83b are located at the first position. In a case where the target distance is included in a range obtained by adding the first distance of the first fixed driver 82 and the adjustable distance of the adjustable driver 81 to the minimum distance from the first holder 4 to the second holder 6, the elevation controller 29 locates the piston rod 82b of the first fixed driver 82 at the second position and the piston rod 83b of the second fixed driver 83 at the first position. In this state, the elevation controller 29 adjusts the advance amount of the rod 81b of the adjustable driver 81 so that the distance from the first holder 4 to the second holder 6 thereby coincides with the target distance. In the hand 10 illustrated in FIG. 5, the piston rod 82b is located at the second position and the piston rod 83b is located at the first position. In a case where the target distance is included in a range obtained by adding the first distance of the first fixed driver 82, the second distance of the second fixed driver 83, and the adjustable distance of the adjustable driver 81 to the minimum distance from the first holder 4 to the second holder 6, the elevation controller 29 locates the piston rod 82b of the first fixed driver 82 at the second position and the piston rod 83b of the second fixed driver 83 at the second position. In this state, the elevation controller 29 adjusts the advance amount of the rod 81b of the adjustable driver 81 so that the distance from the first holder 4 to the second holder 6 thereby coincides with the target distance. In the hand 10 illustrated in FIGS. 2 and 4, the piston rod 82b and the piston rod 83b are located at the second position.

Thereafter, in step S106, the belt controller 210 operates the motor 51 of the first driver 5 to advance the first holder 4 and the second holder 6 to the first position. Accordingly, the suction pads 41 of the first holder 4 and the suction pads 61 of the second holder 6 project forward from the front end of the base plate 31. In addition, the arm controller 26 brings each of the first holder 4 and the second holder 6 into contact with a side of the selected two articles W. Specifically, the arm controller 26 moves the robot arm 11 such that the base plate 31 is located at a height substantially equal or below the bottom of a lower one of the two articles W. At this height, the arm controller 26 brings the suction pads 41 and the suction pads 61 into contact with sides of the corresponding articles W. At this time, the suction controller 211 operates the negative pressure generator 17 and connects the negative pressure generator 17 to the first holder 4 and the second holder 6. Accordingly, the first holder 4 and the second holder 6 start suction. In this manner, the first holder 4 and the second holder 6 adhere to the two articles W.

Subsequently, in step S107, the belt controller 210 operates the motor 51 of the first driver 5 to retract the first holder 4 and the second holder 6 to the second position. Accordingly, the articles W held by the first holder 4 and the second holder 6 are drawn toward the base plate 31 in the first direction X. The articles W drawn in the first direction X, specifically, the lower one of the vertically stacked two articles W, is placed on the conveyance surface 52a of the transfer belts 52. Since the articles W are placed on the conveyance surfaces 52a, the articles W are also conveyed by the transfer belts 52 with a friction force of the conveyance surfaces 52a. That is, the articles W are drawn in the first direction X by the first holder 4, the second holder 6, and the transfer belts 52. In addition, in placing the articles W on the conveyance surfaces 52a, the articles W are also placed on the placement surface 31d of the base plate 31. The placement surface 31d has a small friction coefficient and functions as a sliding surface. That is, the articles W are drawn in the first direction X by the first holder 4, the second holder 6, and the transfer belts 52, with a load thereof being supported by the base plate 31. The articles W are drawn toward the base plate 31 until the first holder 4 and the second holder 6 reach the second position. In this manner, the articles W are placed on the base plate 31.

Suction of the articles W by the first holder 4 and the second holder 6 may be canceled at any time after drawing of the articles W toward the base plate 31 is completed.

Subsequently, in step S108, the articles W are carried out. The arm controller 26 moves the robot arm 11 to move the hand 10 to the target position of the articles W. At this time, the travel controller 25 may cause the carrier 15 to travel as necessary. When the hand 10 reaches the target position, the belt controller 210 operates the motor 51 of the first driver 5 to move the first holder 4 and the second holder 6 forward. The articles W are pushed forward by the first holder 4 and the second holder 6, and drawn forward by the conveyance surfaces 52a of the transfer belts 52. Finally, the articles W are placed at the target position. In this manner, transfer of the two articles W is completed.

When transfer of the two articles W is completed, processes in step S101 and subsequent steps are repeated. The processes in step S101 and subsequent steps are repeated until none of the articles W at the start position is carried out. The hand 10 can hold and convey only one article W at one transfer depending on the size, placement situations, and others of the articles W. For example, in cases such as a case where the articles W are large in size or a case where the last article W in the top-bottom direction is held, the hand 10 holds one article W by both the first holder 4 and the second holder 6 or only by the first holder 4 in some cases.

In the case of holding one or two articles W directly placed on the floor, in step S106, the arm controller 26 moves the robot arm 11 such that the base plate 31 approaches as close to the floor as possible. In the case where the articles W are directly placed on the floor, the base plate 31 cannot be located at a height substantially equal to or below the bottom of the articles W. However, in the hand 10, since the motor 51 does not project from the bottom surface 31b of the base plate 31, the base plate 31 is allowed to approach as close to the floor as possible. Accordingly, articles W held by the first holder 4 are easily drawn onto the base plate 31.

In addition, in the case of holding one or two articles W directly placed on the floor, before the articles W are drawn to the base plate 31 in step S107, the elevation controller 29 operates the elevator 9 and moves the first holder 4 and the second holder 6 upward in the second direction Z. Accordingly, the articles W held by the first holder 4 are lifted upward. In this state, the belt controller 210 operates the motor 51 of the first driver 5 to retract the first holder 4 and the second holder 6 to the second position. At an appropriate timing when a part of the articles W reaches above the base plate 31, the elevation controller 29 operates the elevator 9 and moves the first holder 4 downward in the second direction Z. Accordingly, the articles W held by the first holder 4 are placed on the placement surface 31d of the base plate 31 and the conveyance surfaces 52a of the transfer belts 52. Thereafter, the articles W are drawn toward the base plate 31 until the first holder 4 and the second holder 6 reach the second position. In this manner, the articles W are placed on the base plate 31. Processes in step S108 and subsequent steps are similar to the processes described above.

The hand 10 is used in such transfer of articles W so that conveyance efficiency of the articles W can be thereby enhanced. Specifically, the hand 10 includes the first holder 4 and the second holder 6, and adjusts the distance from the first holder 4 to the second holder 6 in the second direction Z, that is, an interval between the first holder 4 and the second holder 6 in the second direction Z. The hand 10 appropriately adjusts the distance from the first holder 4 to the second holder 6 to thereby appropriately hold two articles W at a time. Accordingly, as compared to the case of conveying articles W one by one by the hand 10, conveyance efficiency of the articles W is enhanced.

In addition, the sizes of two articles W that can be held at a time depend on the distance from the first holder 4 to the second holder 6. The adjustment of the distance from the first holder 4 to the second holder 6 can enlarge the range of size of two articles W that can be held at a time. Even in a case where the hand 10 holds one article W, the application range of holdable articles W can be enlarged by adjusting the distance from the first holder 4 to the second holder 6. That is, limitation of size of articles W that can be held by the hand 10 depends on the distance from the first holder 4 to the second holder 6. A larger article W can be held by increasing the distance from the first holder 4 to the second holder 6. To hold articles W appropriately, the holding position is also important in relation to the centroid of the articles W. The articles W can be held at an appropriate position in relation to the centroid of the articles W by adjusting the distance from the first holder 4 to the second holder 6. That is, in the relationship to the centroid of the articles W, the application range of articles W that can be appropriately held can be enlarged. In the manner described above, the application range of holdable articles W is enlarged irrespective of the number of articles W so that conveyance performance of the hand 10 can be thereby enhanced.

As a result of enlargement of the application range of articles W, the weight of articles W held by the first holder 4 and the second holder 6 may increase. Since the hand 10 includes the two transfer belts 52, a force of drawing articles W is increased by the transfer belts 52. Accordingly, even heavier articles W can be appropriately drawn toward the base 3 by the first holder 4, the second holder 6, and the transfer belts 52.

Furthermore, movement of the second holder 6 in the second direction Z is achieved by combining the adjustable driver 81 and the first fixed driver 82 so that the amount of movement of the second holder 6 can be thereby adjusted within a range wider than the range adjustable by the adjustable driver 81.

### Other Embodiments

In the foregoing section, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new exemplary embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

The robot 1 may not include the carrier 15 and the equipment housing 16. For example, the robot 1 may be fixed. The hand 10 is applied not only to the robot 1 and may be applied to automatic machines or the like that perform fixed operation.

Holding of articles W by the hand 10 is not limited to suction. For example, the first holder 4 and the second holder 6 may include fingers that perform an opening/closing action. That is, the first holder 4 and the second holder 6 may be grippers.

The type of holding of the first holder 4 may be different from the type of holding of the second holder 6. For example, the first holder 4 may be a suction pad and the second holder 6 may be a gripper.

Although the first holder 4 and the second holder 6 are integrally moved in the first direction X by the first driver 5, but the present disclosure is not limited to this example. That is, the first holder 4 and the second holder 6 may be each moved by separate drivers in the first direction X.

The device that drives the first holder 4 and the second holder 6 in the first direction X, that is, the first driver 5, is not limited to a belt-driven device. For example, the first driver 5 may be a feed screw mechanism. That is, the carriage 56 may be moved by a feed screw in the first direction X.

The number of the transfer belts 52 of the first driver 5 is not limited to two. The number of the transfer belts 52 may be one or three or more.

The configuration that moves the second holder 6 in the second direction Z is not limited to the guide 7 and the second driver 8. For example, a configuration in which the guide 7 includes only the first mover 71 and the first guide 74, the second holder 6 is attached to first mover 71, and the second driver 8 is only the adjustable driver 81 that moves the first mover 71 in the second direction Z may be employed. The adjustable driver 81 is not limited to the electric cylinder including the ball screw mechanism. The adjustable driver 81 may be a rack-and-pinion or a belt-driven mechanism.

The second driver 8 may adjust the amount of movement of the second holder 6 in the second direction Z not continuously but stepwise, that is, discretely. Alternatively, the second driver 8 may switch the position of the second holder 6 in the second direction Z selectively between the first position and the second position, that is, may be incapable of adjusting the amount of movement of the second holder 6. The second driver 8 is not limited to the electric cylinder or the air cylinder. The second driver 8 may be a feed screw mechanism, a linkage mechanism, a belt-driven mechanism, or other mechanisms.

The second direction Z as a movement direction of the second holder 6 is not limited to the direction substantially orthogonal to the base plate 31, that is, the top-bottom direction. The second direction Z may be a direction substantially parallel to the base plate 31, that is, the horizontal direction. With this configuration, the hand 10 can hold two laterally disposed articles W at a time with the first holder 4 and the second holder 6. Even in this case, articles W of various sizes in various weight balances can be appropriately held by adjusting a horizontal interval between the first holder 4 and the second holder 6.

The hand 10 may include one or more additional holders in addition to the first holder 4 and the second holder 6. The additional holders may be capable or incapable of adjusting the distance from the first holder 4 in the second direction Z. From the viewpoint of using the multiple transfer belts 52 or avoiding projection from the bottom surface 31b of the base plate 31, only the first holder 4 may be used without the second holder 6.

The hand 10 may not include the imager 19. For example, in a case where arrangement or other features of articles W before holding are known, the imager 19 is unnecessary. Alternatively, an imager separated from the robot 1 may be used.

Articles W are not limited to cardboard boxes. The articles W are not limited to boxes, and may be hemp bags accommodating grain or other substances. In this case, the first holder 4 and the second holder 6 are preferably not suction pads but grippers.

The flowchart of FIG. 9 is merely an example. Steps in the flowchart may be changed, replaced, added, and/or omitted as appropriate. Further, the order of steps in the flowchart may be changed or serial processing may be performed in parallel.

Functions performed by constitutional elements described herein may be implemented in circuitry or processing circuitry including a general-purpose processor, an application-specific processor, an integrated circuit, an application specific integrated circuit (ASIC), a central processing unit (CPU), conventional circuitry, and/or a combination thereof programmed to perform the functions described herein. A processor includes transistors and other circuits, and is regarded as circuitry or arithmetic circuitry. A processor may be a programmed processor that performs programs stored in a memory.

Circuitry, a unit, and means herein are hardware that is programmed to perform or performs the described functions. The hardware may be any hardware disclosed herein, or any hardware programmed or known to perform the functions described.

If the hardware is a processor considered to be of a type of circuitry, the circuitry, means, or a unit is a combination of hardware and software used to configure the hardware and/or the processor.

The techniques disclosed here are summarized as follows.

[1] The hand 10 includes: the base 3; the first holder 4 that is supported to be movable in a predetermined first direction X with respect to the base 3 and holds an article W; the first driver 5 that moves the first holder 4 in the first direction X; and the second holder 6 that is aligned with the first holder 4 in the second direction Z intersecting with the first direction X, is supported to be movable in first direction X with respect to the base 3, and holds the article W, wherein the base 3 allows the article W held by the first holder 4 and the second holder 6 to be placed on the base 3, and second holder 6 is capable of adjusting a distance from the first holder 4 in the second direction Z.

With this configuration, an application range of articles W that can be held by the hand 10 can be enlarged by adjusting the distance from the first holder 4 to the second holder 6 in the second direction Z. For example, two juxtaposed articles W can be respectively held by the first holder 4 and the second holder 6. At this time, articles W of various sizes can be appropriately held by adjusting the distance from the second holder 6 to the first holder 4 in the second direction Z in accordance with the sizes of the two articles W. Even in the case of holding one article W by the first holder 4 and the second holder 6, articles W of various sizes can be appropriately held by adjusting the distance from the second holder 6 to the first holder 4 in the second direction Z. As a result, the application range of holdable articles W is enlarged, and conveyance performance of the hand 10 can be enhanced.

[2] The hand 10 of [1] further includes: the guide 7 that supports the second holder 6 such that the second holder 6 is movable in the second direction Z; and the second driver 8 that moves the second holder 6 in the second direction Z.

With this configuration, the second holder 6 is driven by the second driver 8 in the second direction Z while being guided by the guide 7 in the second direction Z. Accordingly, the distance from the second holder 6 to the first holder 4 in the second direction Z is adjusted.

[3] In the hand 10 of [1] or [2], the guide 7 includes the first mover 71, the first guide 74 that supports the first mover 71 such that the first mover 71 is movable in the second direction Z with respect to the base 3, the second mover 72 on which the second holder 6 is mounted, and the second guide 75 that supports the second mover 72 such that the second mover 72 is movable in the second direction Z with respect to the first mover 71, the second driver 8 includes the adjustable driver 81 capable of adjusting an amount of movement of the second holder 6 and the first fixed driver 82 that moves the second holder 6 with a constant amount of movement, one of the adjustable driver 81 and the first fixed driver 82 drives the first mover 71, and another of the adjustable driver 81 and the first fixed driver 82 drives the second mover 72.

With this configuration, movement of the second holder 6 in the second direction Z is achieved by two-stage movement including movement of the first mover 71 and movement of the second mover 72. One of the adjustable driver 81 and the first fixed driver 82 drives the first mover 71, and the another of the adjustable driver 81 and the first fixed driver 82 drives the second mover 72. Accordingly, the position of the second holder 6 in the second direction Z can be adjusted not only in the adjustable range by the adjustable driver 81 but also in the range obtained by adding the adjustable range of the adjustable driver 81 to a constant amount of movement by the first fixed driver 82. That is, while the configuration of the second driver 8 is simplified by achieving a part of movement of the second holder 6 by the first fixed driver 82, the range in which the position of the second holder 6 can be arbitrarily adjusted can be enlarged by combining the adjustable driver 81 and the first fixed driver 82.

[4] In the hand 10 of any one of [1] to [3], the second direction Z is the top-bottom direction, the second mover 72 is located above the first mover 71, the adjustable driver 81 drives the first mover 71, and the first fixed driver 82 drives the second mover 72.

With this configuration, the adjustable driver 81 can be located relatively below. Since the adjustable driver 81 has a complicated configuration as compared to the first fixed driver 82, the adjustable driver 81 tends to be heavier than the first fixed driver 82. Since the relatively heavy adjustable driver 81 is located below, the centroid of the hand 10 can be lowered.

[5] In the hand 10 of any one of [1] to [4], the adjustable driver 81 is an electric cylinder, and the first fixed driver 82 is an air cylinder.

An electric cylinder tends to be generally heavier than an air cylinder. In the configuration in which the adjustable driver 81 is an electric cylinder and drives the first mover 71, the relatively heavy electric cylinder can be located relatively below. Accordingly, the centroid of the hand 10 can be lowered.

[6] In the hand 10 of any one of [1] to [5], the first driver 5 includes the motor 51 and the transfer belt 52 that transfers a driving force of the motor 51, and the first holder 4 is coupled to the transfer belts 52.

With this configuration, the first holder 4 is driven in the first direction X by the motor 51 through the transfer belt 52.

[7] In the hand 10 of any one of [1] to [6], the transfer belt 52 has the conveyance surface 52a on which the article W held by the first holder 4 is placed, and moves the conveyance surface 52a together with the first holder 4.

With this configuration, the transfer belts 52 moves the first holder 4 and the conveyance surface 52a together in the first direction X. Thus, articles W held by the first holder 4 are placed on the conveyance surface 52a of the transfer belt 52 so that the article W is thereby moved in the first direction X by not only the first holder 4 but also through a friction force between the article W and the conveyance surface 52a.

[8] In the hand 10 of [1] to [7], the first driver 5 includes at least two of the transfer belts 52.

With this configuration, since the article W held by the first holder 4 is placed on the conveyance surfaces 52a of the at least two transfer belts 52, a friction force between the article W and the transfer belts 52 can be increased. That is, conveyance performance of articles W by the transfer belts 52 can be enhanced.

[9] In the hand 10 of any one of [1] to [8], the base 3 includes the base plate 31 having the placement surface 31d on which the article W held by the first holder 4 is placed and the bottom surface 31b at a side opposite to the placement surface 31d, the transfer belt 52 is located at the base plate 31 and extends along the base plate 31, and the motor 51 is located at the base 3 without projecting from the bottom surface 31b.

With this configuration, the transfer belt 52 is arranged along the base plate 31, and thus, the motor 51 is also located near the base plate 31. However, the motor 51 does not project from the bottom surface 31b of the base plate 31. Thus, in holding an article W directly placed on the floor or other places, the base plate 31 is allowed to approach as close to the plane on which the article W is placed as possible. As a result, articles W held by the first holder 4 can be easily drawn onto the base plate 31.

[10] In the hand 10 of any one of [1] to [9], tubes or wires connected to the first holder 4 and the second holder 6, that is, the accommodation duct 35, are located on the base 3 without projecting from the bottom surface 31b.

With this configuration, an object projecting from the bottom surface 31b of the base plate 31 is reduced, and thus, the base plate 31 is allowed to approach as close to the plane on which the article W is placed as possible. As a result, articles W directly placed on the floor or other places can be easily drawn onto the base plate 31.

[11] In the hand 10 of any one of [1] to [10], no other projects project from the bottom surface 31b of the base plate 31.

With this configuration, since no objects project from the bottom surface 31b, the base plate 31 is allowed to approach as close to the plane on which the article W is placed as possible. As a result, articles W directly placed on the floor or other places can be easily drawn onto the base plate 31.

1. A hand comprising:
a base;
a first holder that is supported to be movable in a predetermined first direction with respect to the base and holds an article;
a first driver that moves the first holder in the first direction; and
a second holder that is aligned with the first holder in a second direction intersecting with the first direction, is supported to be movable in the first direction with respect to the base, and holds the article, wherein
the base allows the article held by the first holder and the second holder to be placed on the base, and
the second holder is capable of adjusting a distance from the first holder in the second direction.

2. The hand according to claim 1, further comprising:
a guide that supports the second holder such that the second holder is movable in the second direction; and
a second driver that moves the second holder in the second direction.

3. The hand according to claim 2, wherein
the guide includes
a first mover,
a first guide that supports the first mover such that the first mover is movable in the second direction with respect to the base,
a second mover on which the second holder is mounted, and
a second guide that supports the second mover such that the second mover is movable in the second direction with respect to the first mover,
the second driver includes an adjustable driver capable of adjusting an amount of movement of the second holder and a fixed driver that moves the second holder with a constant amount of movement,
one of the adjustable driver and the fixed driver drives the first mover, and
another of the adjustable driver and the fixed driver drives the second mover.

4. The hand according to claim 3, wherein
the second direction is a top-bottom direction,
the second mover is located above the first mover,
the adjustable driver drives the first mover, and
the fixed driver drives the second mover.

5. The hand according to claim 3, wherein
the adjustable driver is an electric cylinder, and
the fixed driver is an air cylinder.

6. The hand according to claim 1, wherein
the first driver includes a motor, and a transfer belt that transfers a driving force of the motor, and
the first holder is coupled to the transfer belt.

7. The hand according to claim 6, wherein
the transfer belt has a conveyance surface on which the article held by the first holder is placed, and moves the conveyance surface together with the first holder.

8. The hand according to claim 7, wherein
the first driver includes at least two of the transfer belts.

9. The hand according to claim 6, wherein
the base includes a base plate having a placement surface on which the article held by the first holder is placed and a bottom surface at a side opposite to the placement surface,
the transfer belt is located at the base plate and extends along the base plate, and
the motor is located at the base without projecting from the bottom surface.

10. The hand according to claim 9, wherein
tubes or wires connected to the first holder and the second holder are located on the base without projecting from the bottom surface.

11. The hand according to claim 9, wherein
no other objects project from the bottom surface of the base plate.
